(19) United States
(12) Patent Application Publication
(10) Pub. No.: US 2004/0015593 A1
(43) Pub. Date: Jan. 22, 2004

(54) Determining the connection and/or device status of a user terminal

(76) Inventors: Bernhard Krembs, Gruenwald (DE); Gerhard Krauss, Muenchen (DE); Vukica Mirkovic Polajnar, Ljubljana (SI)

Correspondence Address: SIEMENS SCHWEIZ, I-44, INTELLECTUAL PROPERTY, ALBISRIEDERSTRASSE 245, ZURICH, CH-8047, CH

(21) Appl. No.: 10/458,182

(22) Filed: Jun. 11, 2003

Related U.S. Application Data
(63) Continuation of application No. PCT/DE01/04642, filed on Dec. 10, 2001.

(30) Foreign Application Priority Data
Dec. 14, 2000 (DE) 100 62 382.4

(51) Int. Cl. G06F 15/16

(52) U.S. Cl. 709/228

(57) ABSTRACT

A system and method for determining the connection and/or device status of a user terminal is intended primarily to permit more efficient working of operator stations, whereby said operator stations can obtain information on the connection and/or device status of a user terminal to which a call is possibly to be routed by means of a connection channel without establishing a speech channel. An interrogation notice is sent for this purpose with a connection identifier for the user terminal whose connection and/or device status is to be determined from a requesting connection to an exchange for the user terminal. The connection and/or device status of the user terminal is then determined by the exchange. Finally, the determined connection and/or device status is transmitted from the exchange to the requesting connection

### CROSS REFERENCE TO RELATED APPLICATIONS

The present application is a continuation of International Patent Application No.: WO 02/49328, filed Jun. 20, 2002, and further claims priority to German patent application number 10062382.4, filed Dec. 14, 2000, the both of which are herein incorporated by reference.

### BACKGROUND OF THE INVENTION

The present invention relates to a system and method for determining a status, the status including connection status and/or device status, of a user terminal. In particular, the invention comprises a method by which it may be determined from a telephone connection (via a user terminal, operator station and the like), the communication status (e.g. available or busy) and/or the device status (e.g. call diversion activated, call barring etc.) of another user terminal. The invention further relates to a system for carrying out the inventive method.

At present, a need exists to determine the status of a user terminal. Such need is especially present in call centers, wherein an operator, upon receiving an incoming call must first determine if a service representative is free before effecting a connection (between caller and service provider). While the determination is underway, the caller is placed in a holding queue. The determination is typically effected by a time consuming call or callback procedure. Callers typically do not appreciate being placed on hold. Therefore, a need exists to speed up the operator determination step so as to reduce switching time and shorten the waiting time for callers.

U.S. Pat. No. 5,490,251 entitled “Method and apparatus for transmitting data over a signaling channel in a digital telecommunication network” and dated Aug. 9, 1991, discloses a communication system for data exchange between a terminal and a central processor via a signaling channel of an ISDN network By this method, it is not necessary to set up a speech or data channel. In this case credit card transactions, such as a request for authentication, are sent from the terminal to the central processor, evaluated there, and the evaluation results are then sent back to the terminal, The communication takes place exclusively via the signaling channel of the ISDN network. Preferably, both the request to and answer from the central processor contain a “user-user information element” and conform to the CCITT Q.931 standard.

### BRIEF SUMMARY OF TH INVENTION

An object of the present invention is to provide a method by which a subscriber can determine a connection and/or device status of another user terminal in a quick and efficient manner. To determine the connection and/or device status, consideration is given to most if not all information that could potentially be used for an assessment of whether and how a speech channel connection to a destination user terminal from the subscriber can be established.

These and other objects may be achieved by a method according to an embodiment of the present invention as well as a system for performing the method. The method comprises the steps of initially transmitting from the subscriber to an exchange associated with the destination user terminal an interrogation notice together with a connection identifier of the destination user terminal. The connection and device status of the destination user terminal is then queried by the exchange. The status determined by the exchange is then transmitted from The exchange to the subscriber. The status includes at least connection and device status. Other status which may be determined by the destination exchange may also be considered. The term subscriber as used herein includes an operator station or another user terminal. The determined connection and device status of the user terminal may be indicated to the subscriber either visually or acoustically.

Indep Claims

The transmission of the interrogation notice as well as the transmission of the determined connection and device status from the subscriber to the local exchange, or from the local to the destination exchange may occur via a signaling channel, so that establishment of a speech or general user information channel between subscriber and destination user terminal is not necessary.

The transmission sequence of the interrogation notice together with the connection identifier of the destination user terminal to the exchange of the destination user terminal may comprise the following steps:

Transmission of the interrogation notice together with the connection identifier of the user terminal from the subscriber to a local exchange of said subscriber, and

Transmission of the interrogation notice and connection identifier of the destination user terminal from said local exchange to a destination exchange of the destination user terminal.

The step of transmitting the interrogation notice and connection identifier for the destination user terminal, if necessary together with a feature identifier, from the exchange of the subscriber to the exchange of the destination user terminal may occur in a connectionless or packet oriented manner with the aid of the connection identifier of the destination user terminal.

The step of transmitting the interrogation notice and the connection identifier of the destination user terminal from the exchange of the subscriber to the exchange of the destination user terminal may alternatively occur via an ISDN user part connection.

After the step of transmitting the determined connection and device status from the exchange to the subscriber, the subscriber may confirm this transmission by a further message from the subscriber to the exchange. A connection from the subscriber to the exchange is then established.

A system for performing the above described method includes at least one subscriber connected with a local exchange. The local exchange is further connected to a destination exchange, the destination exchange serving the destination user terminal. The connections between the aforementioned may be ISDN and the like, Other systems and configurations are possible provided the aforementioned and below described method steps are facilitated. The present invention will be described with respect to a system comprising the local and destination servers, subscriber and destination user terminal. The aforementioned include an ISDN connection.

### BRIEF DESCRIPTION OF THE SEVERAL VIEWS OF THE DRAWINGS

The novel features and method steps believed characteristic of the invention are set out in the claims below. The invention itself, however, as well as other features and advantages thereof, are best understood by reference to the detailed description, which follows, when read in conjunction with the accompanying drawing, wherein:

FIG. 1 depicts a block diagram of a system for requesting the connection and device status of a user terminal; and

FIG. 2 shows the corresponding notice sequence.

### DETAILED DESCRIPTION OF THE INVENTION

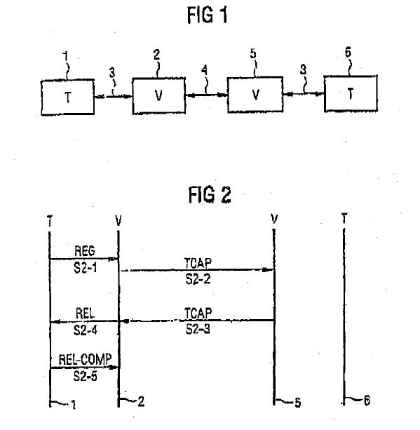

FIG. 1 depicts a block diagram of the present invention. Herein, subscriber 1 is depicted connected 3 with a local exchange 2. The subscriber may also comprise an operator station. The connection 3 may comprise an ISDN connection. The local exchange 2 may in turn communicate with, among other devices, other exchanges such as destination or remote exchange 5 and the like. The remote exchange 5 is depicted connected to a destination user terminal 6, the connection being ISDN. ISDN is an abbreviation for integrated services digital network, wherein the same time-division switches and digital transmission paths are used to establish connections for different services. ISDN services may include telephone, data, electronic mail, and facsimile. In addition, the method used to accomplish a connection is often specified: for example, switched connection, nonswitched connection, exchange connection, and ISDN connection. For illustration purposes, it will be assumed that the connection and device status of destination user terminal 6 is to be determined by subscriber 1.

According to the invention, only signaling channels are used for this connection and device status request process, so that the speech channel resource car. be spared, A speech channel connection can be established later if required and if the request is transmitted via the non-speech channel (signaling channel).

The ISDN D channel is used herein for communication 3 between subscriber 1 and local exchange 2, The TCAP mechanism or an ISDN user part connection (ISUJP) may be used for the inter-exchange signaling 4 between the two exchanges (local) 2 and (remote) 5.

The TCAP (Transaction Capability Application Part) mechanism is a connectionless (packet oriented) SS#7 protocol for the exchange of information that is not in conjunction with a call or a connection. The SS#7 protocol is a signaling protocol developed for digital telephone networks and has been described under ITU-T standards Q.700 to Q.795. It can be used for, among other things. ISDN and ATM.

An ISDN user pan connection (ISUP=ISDN user part) is one of several possible user parts of the SS#7 protocol and is used to transmit additional information between exchanges via the signaling channel.

The interrogation sequence between subscriber and destination end user is depicted in FIG. 2. FIG. 2 will be discussed with the subscriber being an operator station 1 who is inquiring into whether or not its present call can be forwarded to a destination user terminal 6. To do so, operator station 1 requests the connection status of destination user terminal 6 in the following manner.

Operator station 1 sends an interrogation notice (REGISTER) (S2-1), preferably a register, facility or Infot message, together with the connection identifier (subscriber number), if necessary with a feature identifier, to the operator-end (local) exchange 2, Local exchange 2 then establishes a signaling channel 4 to the destination exchange 5 (S2-2). The destination exchange 5 in this case denotes the exchange assigned to destination user terminal 6 whose connection and device status is to be determined.

In the case of the TCAP mechanism, the communication between exchanges 2 and 5 can take place connectionlessly (packet oriented) with the aid of the communicated connection identifier of the user terminal 6 whose connection and device status is to be interrogated.

The destination exchange 5 then determines the connection and device status of the destination user terminal 6. The connection and/or device status indicates whether the destination user terminal 6 is available or busy, whether the connection is blocked or a call diversion is active, and other conceivable states. This determination of the connection and device status is in this case accomplished by the destination exchange 5 alone without the active participation of user terminal 6.

The determined connection and device status of the user terminal 6 is then signaled back via the existing signaling channel 4 (TCAP, ISUP, etc.) from the destination exchange 5 to the local exchange 2 at the operator end (S2-3). There, the information is processed according to the determined connection and device status of destination user terminal 6 and displayed on a screen or other suitable visual or acoustic display of operator station 1. In the course of this processing of the connection status information a conversion can take place, for example, to a language and/or sound chosen by operator station 1, if the display is in text and/or audio form. Other human recognizable indicia may be employed by design.

After, or concurrent with the transmission of the connection and device status information, the exchange 2 at the operator end sends a command (RELEASE) to operator station 1 in order to initiate the release of the signal channel connection between exchange 2 and operator station 1 (S2-4). The release of this connection is then confirmed by the sending of a corresponding message (RELEASE COMPLETE) from operator station 1 to the operator-end exchange 2 (S2-5).

Thus, notified of the connection and device status of the destination user terminal 6, the operator station 1 may use this information to efficiently control the further progress of the pending call that is to be switched. Operator station 1 may, for example, respond as follows depending on the determined connection and device status information.

Take back the call switching attempt,

Through-connect the call to be switched, or

Override an existing call at user terminal 6.

According to a development of the aforementioned technique, another user terminal that requested call processing by operator station 1 may be directly informed regarding the connection and device status determined by the above method, Other external devices connected with the operator station may also be employed by design.

Even if only two exchanges are shown in the above exemplary embodiment, the connection status interrogation process may also take place via a greater number of exchanges by design choice.

The invention being thus described, it will be obvious that the same may be varied in many ways. The variations are not to be regarded as a departure from the spirit and scope of the invention, and all such modifications as would be obvious to one skilled in the art are intended to be included within the scope of the following claims.

We Claim:

1. A method for determining at least one status of a destination user terminal, comprising the steps of:
transmitting an interrogation notice and a connection identifier of a destination user terminal identifier from a subscriber to a destination exchange associated with said terminal;
determining said at least one status at said destination exchange; and
transmitting an indication of said status to said subscriber from said destination exchange.

2. The method according to claim 1, wherein said at least one status comprises one of a connection status and a device status.

3. The method according to claim 1, wherein said subscriber is an operator station and said interrogation notice is a REGISTER.

4. The method according to claim 1, wherein said subscriber is an user terminal.

5. The method according to claim 1, further comprising the steps of: visually indicating said indication at said subscriber.

6. The method according to claim 1, further comprising the steps of. audibly indicating said indication at said subscriber,

7. The method according to claim 1, wherein transmission of said interrogation notice and transmission of said determined connection and device status occurs via a signaling channel.

8. The method according to claim 7, wherein said signaling channel comprises a D channel.

9. The method according to claim 7, wherein said signaling channel comprises TCAP.

10. The method according to claim 9, wherein said step of transmitting an interrogation notice further comprises the steps of:
transmitting said interrogation notice and connection identifier to a local exchange, said local exchange being associated with said subscriber; and
transmitting said interrogation notice and connection identifier from said local to said destination exchange.

11. The method according to claim 10, wherein said step of transmitting said interrogation notice and connection identifier from said local exchange to said destination exchange is performed in a packet oriented manner.

12. The method according to claim 11, wherein said packet oriented manner is in conformance with TCAP, and wherein said transmitting is performed with aid from a connection identifier of said destination user terminal.

13. The method according to claim 10, wherein said step of transmitting said interrogation notice and connection identifier from said local to said destination exchange is performed via an ISDN user part connection.

14. The method according to claim 1, further comprising the steps of. confirming by said subscriber receipt of'said indication, said confirming comprising transmitting a message to a local exchange associated with said subscriber, and releasing a connection between said subscriber and said local exchange,

15. The method according to claim 14, wherein said message comprises a RELEASE message.

16. The method according to claim 1, further comprising the steps of informing another user terminal of said indication upon request to said subscriber from said another user terminal.

17. A system for determining at least one status of a destination user terminal, said system comprising,
means for transmitting an interrogation notice and a connection identifier of a destination user terminal identifier from a subscriber to a destination exchange associated with said terminal,
means for determining said at least one status at said destination exchange; and
means for transmitting an indication of said at least one status to said subscriber from said destination exchange.

18. The system according to claim 17, wherein said at least one status comprises one of a connection status and a device status.

19. The system according to claim 17, wherein said transmitting is performed via packet oriented means.

20. The system according to claim 19, wherein said subscriber further comprises means for indicating said indication to a human observer.
